(19) United States
(12) Patent Application Publication
(10) Pub. No.: US 2024/0098550 A1
(43) Pub. Date: Mar. 21, 2024

(54) INCREASING TRANSMISSION CONTROL PROTOCOL (TCP) THROUGHPUT BY REDUCING TCP ROUND-TRIP TIME (RTT) IN A WIRELESS NETWORK

(71) Applicant: QUALCOMM Incorporated, San Diego, CA (US)

(72) Inventor: Vijayakumar BALASUBRAMANIAN, Chennai (IN)

(21) Appl. No.: 17/932,954

(22) Filed: Sep. 16, 2022

(51) Int. Cl. H04W 28/02; H04L 47/283

(52) U.S. Cl. CPC H04W 28/0236; H04L 47/283; H04W 84/12

(57) ABSTRACT

This disclosure provides systems, methods and apparatus, including computer programs encoded on computer storage media, for increasing the throughput of a link between a TCP server and a TCP client that is hosted by a wireless communication device in a wireless communication network. In some implementations, a TCP round-trip time (RTT) can be reduced by modifying transmit parameters of an intermediary device in the wireless communication network to increase a rate at which TCP data is conveyed over a wireless channel from the intermediary device to the device hosting the TCP client. In some implementations, TCP RTT reduction measures can be implemented opportunistically, associated with the conditions of the wireless channel.

### TECHNICAL FIELD

This disclosure relates generally to wireless communication, including increasing Transmission Control Protocol (TCP) throughput by reducing TCP round-trip time (RTT) in a wireless network.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in a wireless communication device. The wireless communication device can include one or more interfaces and a processing system. The one or more interfaces can be capable of obtaining an indication of channel conditions of a wireless channel supporting a link between the wireless communication device and a second wireless communication device, where the link conveys a transfer control protocol (TCP) flow to the second wireless communication device. The processing system can be capable of selecting a target round trip time (RTT) of the TCP flow in accordance with the channel conditions of the wireless channel, modifying, associated with the target RTT, one or more transmit parameters of the wireless communication device, and outputting TCP data of the TCP flow according to the one or more modified transmit parameters.

Another innovative aspect of the subject matter described in this disclosure can be implemented in a method for wireless communication by a wireless communication device. The method can include obtaining an indication of channel conditions of a wireless channel supporting a link between the wireless communication device and a second wireless communication device, where the link conveys a TCP flow to the second wireless communication device, selecting a target RTT of the TCP flow in accordance with the channel conditions of the wireless channel, modifying, associated with the target RTT, one or more transmit parameters of the wireless communication device, and transmitting TCP data of the TCP flow over the wireless channel to the second wireless communication device according to the one or more modified transmit parameters.

In some implementations of the wireless communication device and method, modifying the one or more transmit parameters can include reducing a transmission opportunity (TXOP) duration of the wireless communication device.

In some implementations of the wireless communication device and method, modifying the one or more transmit parameters can include modifying one or more enhanced distributed channel access (EDCA) parameters of the wireless communication device.

In some implementations of the wireless communication device and method, modifying the one or more EDCA parameters can include increasing a minimum contention window size, increasing a maximum contention window size, or both.

In some implementations, the wireless communication device and method can be configured to select the target RTT according to a bytes-in-flight of the TCP flow.

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects and advantages will become apparent from the description, the drawings and the claims.

### BRIEF DESCRIPTION OF THE DRAWINGS

FIG. 1 shows a pictorial diagram of an example wireless communication network.

FIG. 2 shows a block diagram of a first example wireless communication device.

FIG. 3A shows a block diagram of an example access point (AP).

FIG. 3B shows a block diagram of an example station (STA).

FIG. 4 shows a block diagram of a first example operating environment.

FIG. 5 shows a block diagram of a second example operating environment.

FIG. 6 shows a flowchart illustrating a first example process.

FIG. 7 shows a flowchart illustrating a second example process.

FIG. 8 shows a block diagram of a second example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3^{rd} Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU)-MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to increasing the throughput of a link between a TCP server and a TCP client that is hosted by a wireless communication device in a wireless communication network. Some implementations more particularly relate to increasing a rate at which TCP data is conveyed over a wireless channel from an intermediary device in the wireless communication network to the device hosting the TCP client. In some implementations, increasing the rate at which TCP data is conveyed over the wireless channel can reduce a TCP round-trip time (RTT) constituting an amount of time that elapses between when the TCP server sends a TCP segment over the link and when the TCP server receives an acknowledgment of the TCP segment via the link. In some implementations, the wireless communication network can be a wireless local area network (WLAN), the intermediary device can be an access point (AP), and the device hosting the TCP client can be a station (STA).

In some implementations, the intermediary device can increase the rate at which the TCP data is conveyed over the wireless channel by modifying transmit parameters that affect the scheduling, composition, or both, of transmissions over the wireless channel. In some implementations, the intermediary device can implement a reduced transmission opportunity (TXOP) duration, to mitigate latency associated with transmission of the TCP data over the wireless channel. In some implementations, the intermediary device can implement more relaxed enhanced distributed channel access (EDCA) parameters, such as an increased minimum contention window duration, an increased maximum contention window duration, or both, so that the device hosting the TCP client can, on average, get the chance to acknowledge received TCP data more quickly. In some implementations, the intermediary device can select a target RTT for the TCP flow, and can modify its transmit parameters in accordance with the target RTT.

In some implementations, TCP RTT reduction measures can be implemented opportunistically, associated with the conditions of the wireless channel. In some implementations, the intermediary device can assess the channel conditions to ascertain, determine, calculate, select or obtain an indication of how heavily the channel is being used. If channel utilization is light enough that modifying the transmit parameters for RTT reduction may not be expected to negatively impact wireless network performance, the intermediary device can implement the TCP RTT reduction measures. If channel utilization is heavy enough that modifying the transmit parameters may be expected to negatively impact wireless network performance, the intermediary device can refrain from implementing the TCP RTT reduction measures.

Particular aspects of the subject matter described in this disclosure can be implemented to realize one or more of the following potential advantages. In some implementations, by reducing TCP RTT according to the described techniques, increased TCP data rates may be achieved for communications between TCP servers and TCP clients subject to limitations upon send buffer sizes and numbers of TCP connections. In some implementations, by applying TCP RTT reduction techniques in an opportunistic fashion, opportunities for increased TCP throughput may be capitalized upon when circumstances allow, without compromising the performance of the wireless network.

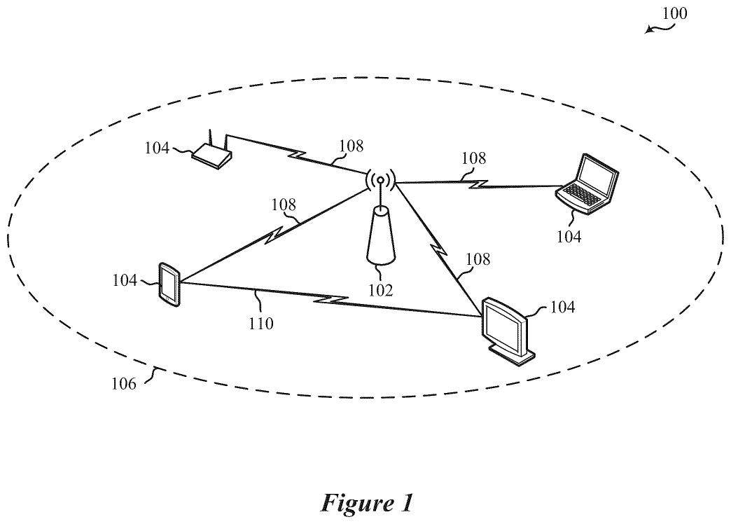

FIG. 1 shows a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2016 specification or amendments thereof including, but not limited to, 802.11ay, 802.11ax, 802.11az, 802.11ba, 802.11bd, 802.11be, 802.11bf, and the 802.11 amendment associated with Wi-Fi 8, etc.). The WLAN 100 may include numerous wireless communication devices such as a wireless AP 102 and multiple wireless STAs 104. While only one AP 102 is shown in FIG. 1, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen (including smart refrigerators) or other household appliances, key fobs (for example, for passive keyless entry and start (PKES) systems), Internet of Things (IoT) devices, automotive vehicles, among other examples.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 108 (hereinafter also referred to as a “Wi-Fi link”), or to maintain a communication link 108, with the AP 102. For example, the beacons can include an identification of a primary channel used by the respective AP 102 as well as a timing synchronization function for establishing or maintaining timing synchronization with the AP 102. The AP 102 may provide access to external networks to various STAs 104 in the WLAN via respective communication links 108.

To establish a communication link 108 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate associated with the scanning information obtained through the passive or active scans, and to perform authentication and association operations to establish a communication link 108 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 108, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link and other P2P group connections.

The APs 102 and STAs 104 may function and communicate (via the respective communication links 108) according to the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications”) to and from one another in the form of PHY protocol data units (PPDUs) (or physical layer convergence protocol (PLCP) PDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band and the 900 MHz band. Some implementations of the APs 102 and STAs 104 described herein also may communicate in other frequency bands, such as the 5.9 GHz band and the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4, 5 GHz or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

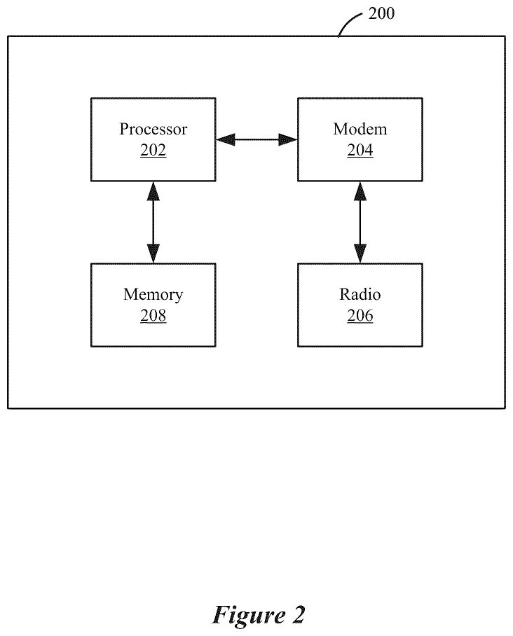

FIG. 2 shows a block diagram of a first example wireless communication device 200. In some implementations, the wireless communication device 200 can be an example of a device for use in a STA such as one of the STAs 104 described above with reference to FIG. 1. In some implementations, the wireless communication device 200 can be an example of a device for use in an AP such as the AP 102 described above with reference to FIG. 1. The wireless communication device 200 is capable of transmitting and receiving wireless communications in the form of, for example, wireless packets. For example, the wireless communication device can be configured to transmit and receive packets in the form of PPDUs and MAC protocol data units (MPDUs) conforming to an IEEE 802.11 wireless communication protocol standard, such as that defined by the IEEE 802.11-2016 specification or amendments thereof including, but not limited to, 802.11ay, 802.11ax, 802.11az, 802.11ba, 802.11bd and 802.11be.

The wireless communication device 200 can be, or can include, a chip, system on chip (SoC), chipset, package or device that includes one or more modems 204, for example, a Wi-Fi (IEEE 802.11 compliant) modem. In some implementations, the one or more modems 204 (collectively “the modem 204”) additionally include a WWAN modem (for example, a 3GPP 4G LTE or 5G compliant modem). In some implementations, the wireless communication device 200 also includes one or more processors, processing blocks or processing elements 202 (collectively “the processor 202”) coupled with the modem 204. In some implementations, the wireless communication device 200 additionally includes one or more radios 206 (collectively “the radio 206”) coupled with the modem 204. In some implementations, the wireless communication device 200 further includes one or more memory blocks or elements 208 (collectively “the memory 208”) coupled with the processor 202 or the modem 204.

The modem 204 can include an intelligent hardware block or device such as, for example, an application-specific integrated circuit (ASIC), among other examples. The modem 204 is generally configured to implement a PHY layer, and in some implementations, also a portion of a MAC layer (for example, a hardware portion of the MAC layer). For example, the modem 204 is configured to modulate packets and to output the modulated packets to the radio 206 for transmission over the wireless medium. The modem 204 is similarly configured to obtain modulated packets received by the radio 206 and to demodulate the packets to provide demodulated packets. In addition to a modulator and a demodulator, the modem 204 may further include digital signal processing (DSP) circuitry, automatic gain control (AGC) circuitry, a coder, a decoder, a multiplexer and a demultiplexer. For example, while in a transmission mode, data obtained from the processor 202 may be provided to an encoder, which encodes the data to provide coded bits. The coded bits may then be mapped to a number N_{SS} of spatial streams for spatial multiplexing or a number N_{STS} of space-time streams for space-time block coding (STBC). The coded bits in the streams may then be mapped to points in a modulation constellation (using a selected MCS) to provide modulated symbols. The modulated symbols in the respective spatial or space-time streams may be multiplexed, transformed via an inverse fast Fourier transform (IFFT) block, and subsequently provided to the DSP circuitry (for example, for Tx windowing and filtering). The digital signals may then be provided to a digital-to-analog converter (DAC). The resultant analog signals may then be provided to a frequency upconverter, and ultimately, the radio 206. In implementations involving beamforming, the modulated symbols in the respective spatial streams are precoded via a steering matrix prior to their provision to the IFFT block.

While in a reception mode, the DSP circuitry is configured to acquire a signal including modulated symbols received from the radio 206, for example, by detecting the presence of the signal and estimating the initial timing and frequency offsets. The DSP circuitry is further configured to digitally condition the signal, for example, using channel (narrowband) filtering and analog impairment conditioning (such as correcting for I/Q imbalance), and by applying digital gain to ultimately obtain a narrowband signal. The output of the DSP circuitry may then be fed to the AGC, which is configured to use information extracted from the digital signals, for example, in one or more received training fields, to ascertain, determine, calculate, select, or obtain an indication of an appropriate gain. The output of the DSP circuitry also is coupled with a demultiplexer that demultiplexes the modulated symbols when multiple spatial streams or space-time streams are received. The demultiplexed symbols may be provided to a demodulator, which is configured to extract the symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits may then be descrambled and provided to the MAC layer (the processor 202) for processing, evaluation or interpretation.

The radio 206 generally includes at least one radio frequency (RF) transmitter (or “transmitter chain”) and at least one RF receiver (or “receiver chain”), which may be combined into one or more transceivers. For example, each of the RF transmitters and receivers may include various analog circuitry including at least one power amplifier (PA) and at least one low-noise amplifier (LNA), respectively. The RF transmitters and receivers may, in turn, be coupled to one or more antennas. For example, in some implementations, the wireless communication device 200 can include, or be coupled with, multiple transmit antennas (each with a corresponding transmit chain) and multiple receive antennas (each with a corresponding receive chain). The symbols output from the modem 204 are provided to the radio 206, which then transmits the symbols via the coupled antennas. Similarly, symbols received via the antennas are obtained by the radio 206, which then provides the symbols to the modem 204.

The processor 202 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 202 processes information received through the radio 206 and the modem 204, and processes information to be output through the modem 204 and the radio 206 for transmission through the wireless medium. For example, the processor 202 may implement a control plane and at least a portion of a MAC layer configured to perform various operations related to the generation, transmission, reception and processing of MPDUs, frames or packets. In some implementations, the MAC layer is configured to generate MPDUs for provision to the PHY layer for coding, and to receive decoded information bits from the PHY layer for processing as MPDUs. The MAC layer may further be configured to allocate time and frequency resources, for example, for OFDMA, among other operations or techniques. In some implementations, the processor 202 may generally control the modem 204 to cause the modem to perform various operations described above.

The memory 204 can include tangible storage media such as random-access memory (RAM) or read-only memory (ROM), or combinations thereof. The memory 204 also can store non-transitory processor- or computer-executable software (SW) code containing instructions that, when executed by the processor 202, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

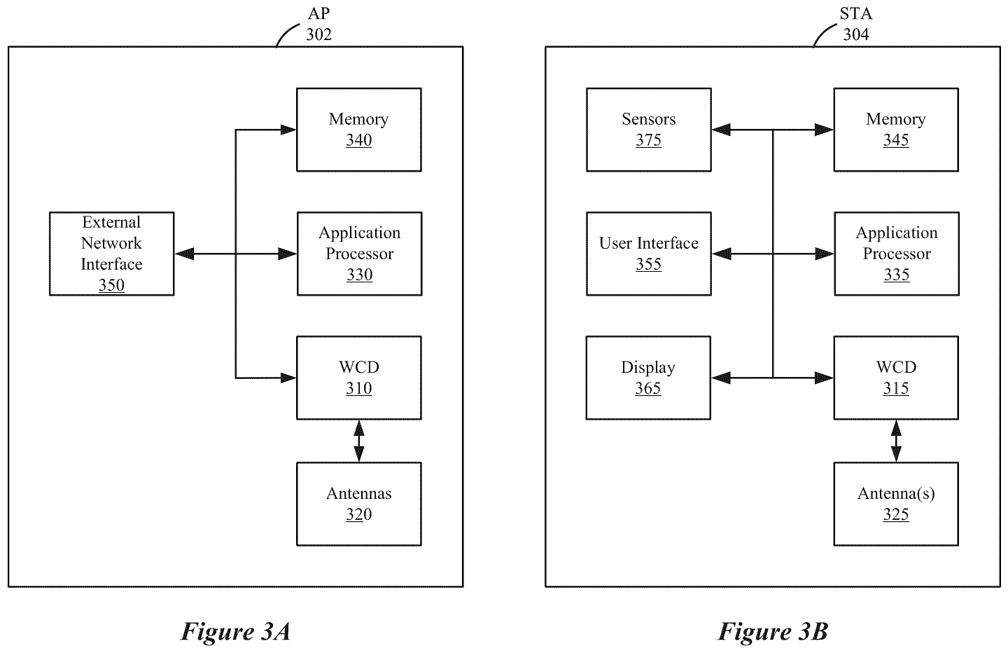

FIG. 3A shows a block diagram of an example AP 302. For example, the AP 302 can be an example implementation of the AP 102 described with reference to FIG. 1. The AP 302 includes a wireless communication device (WCD) 310 (although the AP 302 may itself also be referred to generally as a wireless communication device as used herein). For example, the wireless communication device 310 may be an example implementation of the wireless communication device 200 described with reference to FIG. 2. The AP 302 also includes multiple antennas 320 coupled with the wireless communication device 310 to transmit and receive wireless communications. In some implementations, the AP 302 additionally includes an application processor 330 coupled with the wireless communication device 310, and a memory 340 coupled with the application processor 330. The AP 302 further includes at least one external network interface 350 that enables the AP 302 to communicate with a core network or backhaul network to gain access to external networks including the Internet. For example, the external network interface 350 may include one or both of a wired (for example, Ethernet) network interface and a wireless network interface (such as a WWAN interface). Ones of the aforementioned components can communicate with other ones of the components directly or indirectly, over at least one bus. The AP 302 further includes a housing that encompasses the wireless communication device 310, the application processor 330, the memory 340 and at least portions of the antennas 320 and external network interface 350.

FIG. 3B shows a block diagram of an example STA 304. For example, the STA 304 can be an example implementation of the STA 104 described with reference to FIG. 1. The STA 304 includes a wireless communication device 315 (although the STA 304 may itself also be referred to generally as a wireless communication device as used herein). For example, the wireless communication device 315 may be an example implementation of the wireless communication device 200 described with reference to FIG. 2. The STA 304 also includes one or more antennas 325 coupled with the wireless communication device 315 to transmit and receive wireless communications. The STA 304 additionally includes an application processor 335 coupled with the wireless communication device 315, and a memory 345 coupled with the application processor 335. In some implementations, the STA 304 further includes a user interface (UI) 355 (such as a touchscreen or keypad) and a display 365, which may be integrated with the UI 355 to form a touchscreen display. In some implementations, the STA 304 may further include one or more sensors 375 such as, for example, one or more inertial sensors, accelerometers, temperature sensors, pressure sensors, or altitude sensors. Ones of the aforementioned components can communicate with other ones of the components directly or indirectly, over at least one bus. The STA 304 further includes a housing that encompasses the wireless communication device 315, the application processor 335, the memory 345 and at least portions of the antennas 325, UI 355 and display 365.

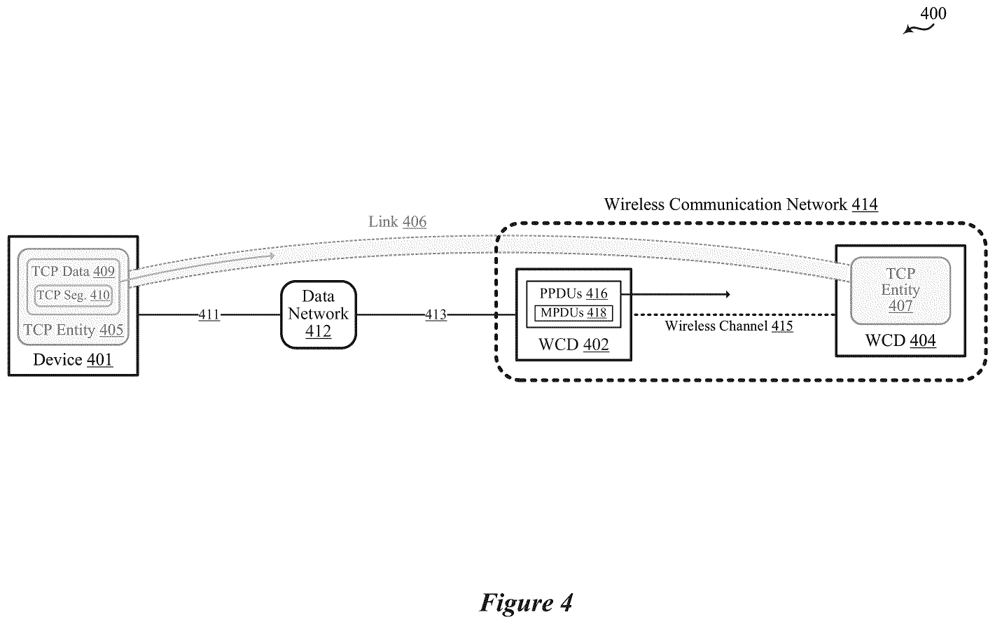

FIG. 4 shows a block diagram of a first example operating environment 400. In some implementations, techniques for increasing TCP throughput by reducing TCP RTT in a wireless network can be implemented in the operating environment 400. In the operating environment 400, a link 406 provides transport-layer connectivity between a transmission control protocol (TCP) entity 405 at a device 401, and a TCP entity 407 at a wireless communication device (WCD) 404 in a wireless communication network 414. In some implementations, the TCP entity 405 can be a TCP client, and the TCP entity 407 can be a TCP server.

In some implementations, the link 406 can represent a TCP connection between the TCP entities 405 and 407, which can engage in a connection establishment procedure to create the link 406. In the operating environment 400, the link 406 can convey, from the TCP entity 405 to the TCP entity 407, a TCP flow made up of the TCP data 409 that the TCP entity 405 sends to the TCP entity 407. The TCP data 409 can include one or more TCP segments 410, each of which can convey a portion of application-layer data associated with an application executing at the device 401 along with a segment header. The application can generate a stream of application-layer data, and the TCP entity 405 can parse the stream into “chunks,” each of which it can encapsulate in a respective TCP segment 410. The TCP entity 407 can receive the TCP data 409 including the TCP segments 410 via the link 406, extract the chunks of data from the TCP segments 410, and reconstruct the application-layer data of the stream.

Communications over the link 406 can use a positive acknowledgment protocol, according to which the TCP entity 407 is required to acknowledge the receipt of the TCP segments 410. According to the protocol, after sending a TCP segment 410 over the link 406 to the TCP entity 407, the TCP entity 405 can refrain from sending a next TCP segment 410 until it receives acknowledgement from the TCP entity 407 of successful receipt of the first TCP segment 410. As such, TCP throughput can be associated with the TCP round-trip time (RTT)— the amount of time that elapses between when the TCP entity 405 sends a TCP segment 410 and when it receives acknowledgment of receipt of that TCP segment 410.

In the wireless communication network 414, the wireless communication device 404 can communicate with a wireless communication device 402 via a wireless channel 415. In some implementations, the wireless communication network 414 can be a WLAN, the wireless communication device 402 can be an AP of the WLAN, and the wireless communication device 404 can be a STA. In some implementations, the wireless communication device 404 can be implemented using the STA 304 of FIG. 3B, the wireless communication device 402 can be implemented using the AP 302 of FIG. 3A, or both.

In some implementations, the wireless channel 415 between the wireless communication devices 402 and 404 can provide part of the lower-layer connectivity that supports the transport-layer connection—in the form of the link 406—between the TCP entities 405 and 407. The transport-layer connection also can be supported in part by lower-layer connectivity between the device 401 and the wireless communication device 402. In some implementations, connectivity between the device 401 and the wireless communication device 402 may be established via a data network 412. In some implementations, the data network 412 can be a packet data network, such as the Internet. Connectivity between the device 401 and the data network 412 can be provided by a connection 411, and connectivity between the wireless communication device 402 and the data network 412 can be provided by a connection 413. The connections 411 and 413 can be wired connections, wireless connections, optical communication connections, or a combination of both. In some implementations, one or both of the connections 411 and 413 can be “multi-hop” connections through one or more intermediate devices or networks. For instance, the connection 413 between the wireless communication device 402 and the data network 412 can include a connection with an access network of an internet service provider (ISP). In some implementations, the wireless communication device 402 may communicate with the device 401 via a direct connection, or via an indirect connection, such as through the access network of the ISP, that does not include the data network 412.

When the TCP entity 405 sends the TCP data 409 over the link 406 to the TCP entity 407, the TCP data 409 can pass from the device 401 to the wireless communication device 402, via the connection 411, the data network 412 and the connection 413. The wireless communication device 402 can deliver the TCP data 409 to the wireless communication device 404 by encapsulating the TCP data 409 within one or more MPDUs 418, encapsulating the one or more MPDUs 418 within one or more PPDUs 416, and transmitting the one or more PPDUs 416 over the wireless channel 415 to the wireless communication device 404. The wireless communication device 404 can extract the one or more MPDUs 418 from the one or more PPDUs 416, extract the TCP data 409 from the one or more MPDUs 418, and provide the TCP data 409 to the TCP entity 407. In some implementations, the TCP data 409 can be encapsulated in network layer PDUs (for example, IP datagrams), and the network layer PDUs, rather than the TCP data 409 itself, can be encapsulated in the one or more MPDUs 418.

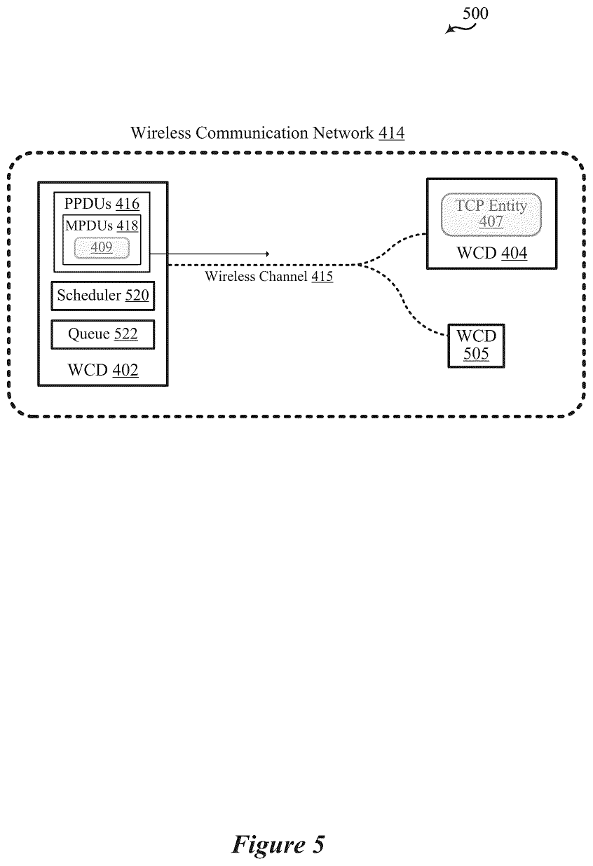

FIG. 5 shows a block diagram of a second example operating environment 500. In some implementations, techniques for increasing TCP throughput by reducing TCP RTT in a wireless network can be implemented in the operating environment 500. In the operating environment 500, a scheduler 520 of the wireless communication device 402 may be responsible for scheduling data transmissions of the wireless communication device 402 over the wireless channel 415. These can include transmissions of the TCP data 409 to the wireless communication device 404 and transmissions of other data to other wireless communication devices in the wireless communication network 414, such as a wireless communication device 505. As the wireless communication device 402 identifies data to be transmitted to devices in the wireless communication network 414 it can add that data to a queue 522, and the scheduler 520 can subsequently schedule transmission of that data in conjunction with servicing the queue 522.

In some implementations, the scheduler 520 can be configured to schedule data transmissions over the wireless channel 415 to optimize MAC efficiency, by using the maximum transmission opportunity (TXOP) duration available to it. However, the longer the TXOP duration that the wireless communication device 402 uses, the longer that other devices in the wireless communication network 414 have to wait before they can gain use of the wireless channel 415. With respect to the wireless communication device 404, a longer TXOP duration can thus delay the delivery of TCP acknowledgements (ACKs) generated by the TCP entity 407, and increase the TCP RTT, resulting in decreased TCP throughput.

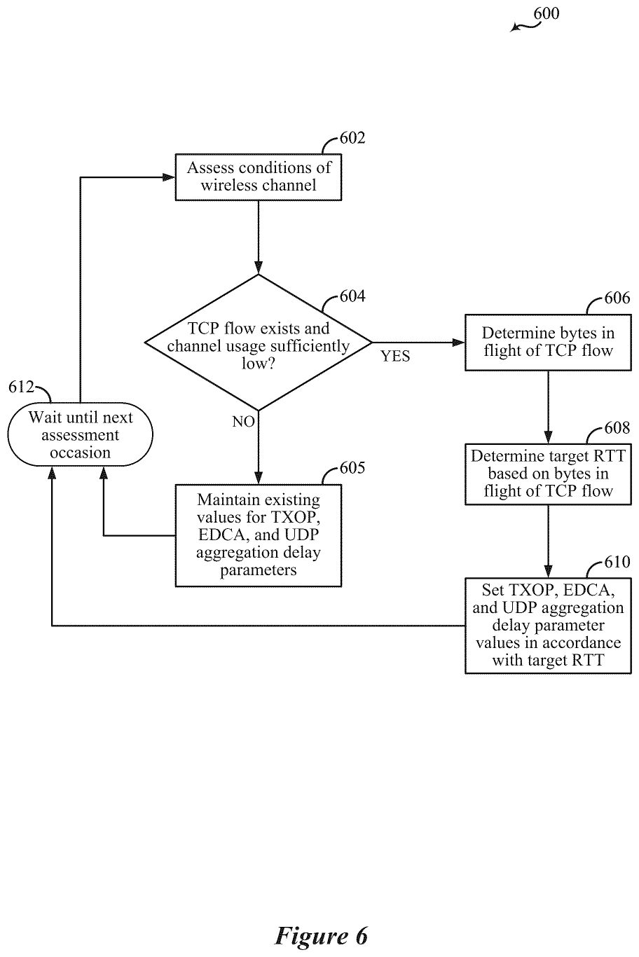

FIG. 6 shows a flowchart illustrating a first example process 600. In some implementations, the process 600 can be implemented to opportunistically modify transmit parameters of a wireless communication device in a wireless communication network to improve throughput of TCP data over a transport-layer link supported by a wireless channel of the wireless communication network. The operations of the process 600 may be implemented by a wireless communication device or its components as described herein. For instance, in some implementations, the operations of the process 600 may be implemented by the wireless communication device 402 depicted in FIGS. 4 and 5. In some implementations, the wireless communication device 402 may implement the process 600 to improve throughput of the TCP data 409 over the link 406 supported by the wireless channel 415 of the wireless communication network 414 of FIG. 4. In some implementations, a wireless communication device that performs operations of the process 600 can be an AP in a WLAN. For example, according to various implementations, the wireless communication network 414 of FIGS. 4 and 5 can be a WLAN, and the wireless communication device 402 can be an AP of that WLAN and can perform operations of the process 600. In some implementations, one of the APs 102 and 302 depicted in FIGS. 1 and 3A, respectively, can be used to implement an AP that performs operations of the process 600.

In a block 602, conditions of the wireless channel can be assessed. For example, in the operating environment 500 of FIG. 5, the wireless communication device 402 can assess conditions of the wireless channel 415. In some implementations, this assessment can include ascertaining, determining, calculating, selecting or obtaining an indication of a utilization level of the wireless channel. In some implementations, ascertaining, determining, calculating, selecting or obtaining an indication of a utilization level of the wireless channel can include comparing, with a number of time units in a given time interval, a number of those time units during which there is traffic scheduled on the wireless channel. In some implementations, the number of time units during which there is traffic scheduled on the wireless channel can be ascertained, determined or calculated by consulting scheduling information for the wireless channel. In some implementations, the utilization level can indicate a percentage of time during a given time interval that the wireless channel will be occupied.

In some implementations, MAC counter information can be used to ascertain, determine, calculate or obtain an indication of a utilization level of the wireless channel. In some implementations, the MAC counter information can indicate respective numbers of idle cycles and non-idle cycles within a given time interval. In some implementations, the utilization level can be ascertained, determined, or calculated, or an indication of the utilization level can be obtained, as a percentage of the total number of cycles in the time interval that are non-idle cycles.

In a block 604, it can be ascertained whether any TCP flow is being conveyed by the wireless channel and whether the current level of usage of the wireless channel is sufficiently low to opportunistically modify transmit parameters of the wireless communication device to improve TCP data throughput. In some implementations, whether the current level of usage of the wireless channel is sufficiently low can be ascertained made by comparing a utilization level ascertained, determined or calculated in the block 602, or indicated by an indication obtained at the block 602, to a threshold. In some implementations, the threshold can represent a ratio between a number of time units, in a given time interval, during which there is traffic scheduled on the wireless channel and a total number of time units in that given time interval. In some implementations, the threshold can represent a percentage of time during a given time interval that the wireless channel can be occupied. In a non-limiting example, the threshold can be ˜55%, such that channel usage is considered sufficiently light if it is less than 55%, and is considered too heavy if it is greater than 55%.

In a block 606, and responsive to ascertainment in the block 604 that a TCP flow exists and channel usage is sufficiently low, the wireless communication device can ascertain, determine, calculate, or obtain an indication of a bytes-in-flight of the TCP flow. In some implementations, the bytes-in-flight of the TCP flow can be ascertained, determined or calculated, or an indication of the bytes-in-flight of the TCP flow can be obtained, for a given interval according to a maximum queue depth of data of the TCP flow during that interval. In some implementations, a maximum number of bytes in a medium access control service data unit (MSDU) queue can be measured over a time interval starting when the MSDU queue becomes active (non-empty) and ending when the MSDU queue becomes inactive (empty), and a bytes-in-flight of the TCP flow for the time interval can be ascertained, determined, or calculated as that maximum number of bytes. In some implementations, the bytes-in-flight of the TCP flow can be observed in a WLAN driver.

In a block 608, the wireless communication device can ascertain, determine, calculate, select, or obtain an indication of a target RTT for the TCP flow associated with the bytes-in-flight of the TCP flow as ascertained, determined or calculated in the block 606, or as indicated by an indication obtained in the block 606. In some implementations, the target RTT for the TCP flow can be ascertained, determined or calculated as a ratio between the bytes-in-flight of the TCP flow and a PHY communication rate of a peer device to which the TCP flow is being delivered.

In a block 610, the wireless communication device can set various transmit parameter values in accordance with a target RTT ascertained, determined or calculated in the block 608, or indicated by an indication obtained in the block 608. In some implementations, the wireless communication device can set a TXOP duration in accordance with the target RTT. In some implementations, this can involve adopting a reduced TXOP duration. In some implementations, the wireless communication device can ascertain, determine, calculate, or obtain an indication of the TXOP duration associated with the target RTT and the minimum and maximum allowable TXOP duration values. In some implementations, the wireless communication device can multiply the maximum allowable TXOP duration by the channel utilization level to obtain a candidate TXOP duration value. If the candidate TXOP duration value is less than the target RTT but not less than the minimum allowable TXOP duration, the wireless communication device can set the TXOP duration to the candidate TXOP duration value. If the target RTT is less than the candidate TXOP duration value but not less than the minimum allowable TXOP duration, the wireless communication device can set the TXOP duration to the target RTT. If both the candidate TXOP duration value and the target RTT are lower than the minimum allowable TXOP duration, the wireless communication device can set the TXOP duration to the minimum allowable TXOP duration.

In the block 610, the wireless communication device can set EDCA parameter values. In some implementations, setting the EDCA parameter values can include increasing a minimum contention window size of the wireless communication device, increasing a maximum contention window size of the wireless communication device, or both. In some implementations, the minimum and maximum contention window sizes can be set to values larger than those of the respective minimum and maximum contention window sizes of the peer device to which the TCP flow is being delivered.

Additionally, or alternatively, in the block 610, the wireless communication device can set a UPD aggregation delay parameter value in accordance with the target RTT. In some implementations, setting the UPD aggregation delay parameter value can include increasing the UPD aggregation delay parameter value associated with a difference between an average UDP TXOP duration and a maximum PPDU TXOP duration.

In the block 612, the wireless communication device can wait until a next occasion to assess the conditions of the wireless channel.

If it is ascertained in the block 604 that no TCP flow exists or that the level of channel usage is not sufficiently low, the process 600 may proceed to a block 605. In the block 605, existing values can be maintained for the TXOP, EDCA and UDP aggregation delay parameters of the wireless communication device. The process 600 may then proceed to the block 612, where the wireless communication device can wait until a next occasion to assess the conditions of the wireless channel.

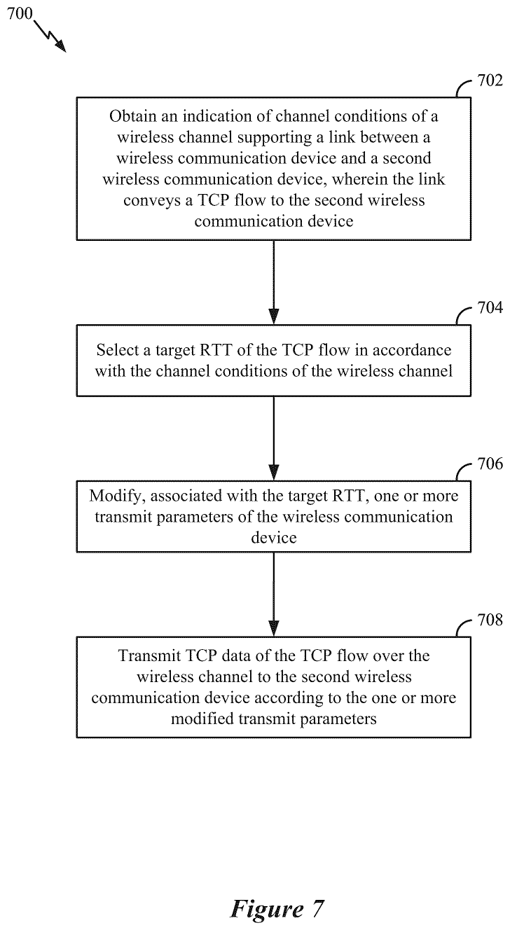

FIG. 7 shows a flowchart illustrating a second example process 700. In some implementations, the process 700 can support increasing TCP throughput by reducing TCP RTT in a wireless network. The operations of the process 700 may be implemented by a wireless communication device or its components as described herein. In some implementations, a wireless communication device that performs operations of the process 700 can be an AP in a WLAN. For example, according to various implementations, the wireless communication network 414 depicted in FIGS. 4 and 5 can be a WLAN, and the wireless communication device 402 can be an AP of that WLAN and can perform operations of the process 700. In some implementations, one of the APs 102 and 302 depicted in FIGS. 1 and 3A, respectively, can be used to implement an AP that performs operations of the process 700.

In a block 702, the wireless communication device can obtain an indication of channel conditions of a wireless channel supporting a link between a wireless communication device and a second wireless communication device, where the link conveys a TCP flow to the second wireless communication device. For example, in the operating environment 400 of FIG. 4, the wireless communication device 402 can obtain an indication of the channel conditions of the wireless channel 415, which can support the link 406 conveying the TCP data 409 to the wireless communication device 404.

In a block 704, the wireless communication device can select a target RTT of the TCP flow in accordance with the channel conditions of the wireless channel. For example, in the operating environment 400 of FIG. 4, the wireless communication device 402 can select a target RTT of the TCP flow including the TCP data 409 in accordance with the conditions of the wireless channel 415. In some implementations, the target RTT of the TCP flow can be selected according to a bytes-in-flight of the TCP flow. In some implementations, wireless communication device can obtain an indication of the bytes-in-flight of the TCP flow from a device driver, such as a WLAN driver.

In a block 706, the wireless communication device can modify, associated with the target RTT, one or more transmit parameters of the wireless communication device. For example, in the operating environment 400 of FIG. 4, the wireless communication device 402 can modify one or more of its transmit parameters associated with the target RTT. In some implementations, modifying the one or more transmit parameters can include reducing a TXOP duration of the wireless communication device. In some implementations, modifying the one or more transmit parameters can include reducing a transmission (TX) aggregation delay of the wireless communication device. In some implementations, modifying the one or more transmit parameters can include modifying one or more enhanced distributed channel access (EDCA) parameters of the wireless communication device. In some implementations, modifying the one or more EDCA parameters can include increasing a minimum contention window size, increasing a maximum contention window size, or both.

In a block 708, the wireless communication device can transmit TCP data of the TCP flow over the wireless channel to the second wireless communication device according to the one or more modified transmit parameters. For example, in the operating environment 400 of FIG. 4, the wireless communication device 402 can transmit the TCP data 409 over the wireless channel 415 to the wireless communication device 404 according to one or more modified transmit parameters adopted in the block 706. In some implementations, subsequent to transmitting the TCP data of the TCP flow over the wireless link to the second wireless communication device according to the one or more modified transmit parameters, associated with an increase in a utilization level of the wireless channel, the wireless communication device can revert at least one of the one or more modified transmit parameters to a previous value.

In some implementations, in conjunction with the process 700, the wireless communication device can check an MSDU queue for a presence of MSDUs associated with TCP flows. In some implementations, the wireless communication device can select the target RTT associated with a presence in the MSDU queue of MSDUs associated with the TCP flow. In some implementations, the wireless communication device can, associated with a number of times per second that the MSDU queue becomes empty, checking the MSDU queue for bursty traffic. In some implementations, associated with finding bursty traffic associated with a non-TCP flow in the MSDU queue, the wireless communication device can increase an aggregation delay for MSDUs including data of the non-TCP flow. In some implementations, the non-TCP flow can be a UDP flow. In some implementations, the non-TCP flow can include traffic associated with an EDCA voice (VO) access category (AC). In some implementations, the non-TCP flow can include traffic associated with an EDCA video (VI) access category (AC).

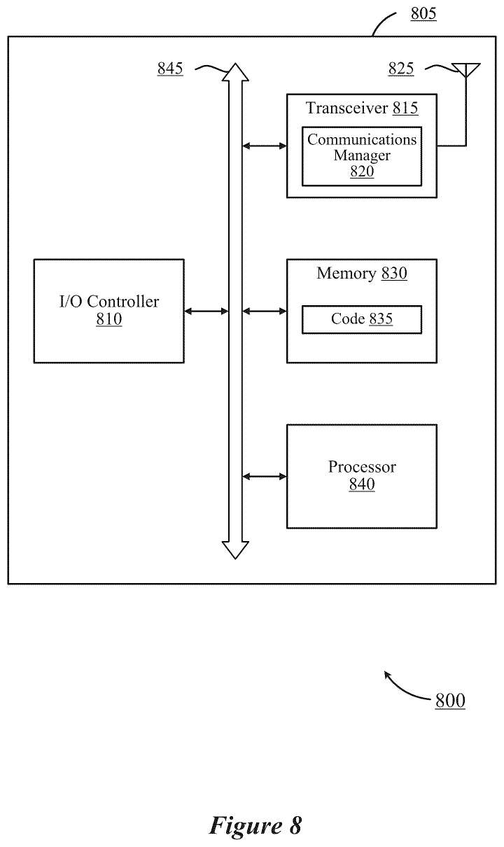

FIG. 8 shows a block diagram of a second example wireless communication device 800. In some implementations, the wireless communication device 800 can support increasing TCP throughput by reducing TCP RTT in a wireless network. In some implementations, the wireless communication device 800 can be configured to perform the process 600 described above with reference to FIG. 6, the process 700 described above with reference to FIG. 7, or both. The wireless communication device 800 may be an example implementation of the wireless communication device 200 described above with reference to FIG. 2, the wireless communication device 402 described above with reference to FIGS. 4 and 5, or both. For example, the wireless communication device 800 can be a chip, SoC, chipset, package or device that includes at least one processor (such as the processor 202), at least one modem (for example, a Wi-Fi (IEEE 802.11) modem or a cellular modem such as the modem 204), at least one memory (such as the memory 208), and at least one radio (such as the radio 206). In some implementations, the wireless communication device 800 can be a device for use in an AP, such as one of the APs 102 and 302 described above with reference to FIGS. 1 and 3A, respectively. In some other implementations, the wireless communication device 800 can be an AP that includes such a chip, SoC, chipset, package or device as well as at least one antenna (such as the antennas 320).

The device 805 may include components for bi-directional communications including components for transmitting and receiving communications, such as a communications manager 820, an input/output (I/O) controller 810, a transceiver 815, an antenna 825, a memory 830, code 835 and a processor 840. These components may be in electronic communication or otherwise coupled (such as operatively, communicatively, functionally, electronically, electrically) via one or more buses (such as a bus 845).

The I/O controller 810 may manage input and output signals for the device 805. The I/O controller 810 also may manage peripherals not integrated into the device 805. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some implementations, the I/O controller 810 may be implemented as part of a processor or processing system, such as the processor 840. In some implementations, a user may interact with the device 805 via the I/O controller 810 or via hardware components controlled by the I/O controller 810.

In some implementations, the device 805 may include a single antenna 825. However, in some other implementations, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 also may include a modem to modulate the packets, to provide the modulated packets to one or more antennas 825 for transmission, and to demodulate packets received from the one or more antennas 825.

In some implementations, the transceiver 815 may include one or more interfaces, such as one or more interfaces coupled with the one or more antennas 825 that are configured to support various receiving or obtaining operations, or one or more interfaces coupled with the one or more antennas 825 that are configured to support various transmitting or outputting operations, or a combination thereof. In some implementations, the transceiver 815 may include or be configured for coupling with one or more processors or memory components that are operable to perform or support operations associated with received or obtained information or signals, or to generate information or other signals for transmission or other outputting, or any combination thereof. In some implementations, the transceiver 815, or the transceiver 815 and the one or more antennas 825, or the transceiver 815 and the one or more antennas 825 and one or more processors or memory components (for example, the processor 840, or the memory 830, or both), may be included in a chip or chip assembly that is installed in the device 805.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some implementations, the code 835 may not be directly executable by the processor 840 but may cause a computer (for example, when compiled and executed) to perform functions described herein. In some implementations, the memory 830 may contain, among other things, a basic I/O system (BIOS) which may control basic hardware or software operation such as the interaction with peripheral components or devices.

The processor 840 may be any one or more suitable processors capable of executing scripts or instructions of one or more software programs stored in the device 805 (such as within the memory 830). In some implementations, the processor 840 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 840, or the transceiver 815, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system, a first interface to output information and a second interface to obtain information. In some implementations, the first interface may refer to an interface between the processing system of the chip or modem and a transmitter, such that the device 805 may transmit information output from the chip or modem. In some implementations, the second interface may refer to an interface between the processing system of the chip or modem and a receiver, such that the device 805 may obtain information or signal inputs, and the information may be passed to the processing system. A person having ordinary skill in the art will readily recognize that the first interface also may obtain information or signal inputs, and the second interface also may output information or signal outputs.

The communications manager 820 may support wireless communication by wireless communication device 800 in accordance with examples as disclosed herein. For example, the communications manager 820 may be configured as or otherwise support a means for obtaining an indication of channel conditions of a wireless channel supporting a link between a wireless communication device and a second wireless communication device, where the link conveys a TCP flow to the second wireless communication device. The communications manager 820 may be configured as or otherwise support a means for selecting a target RTT of the TCP flow in accordance with the channel conditions of the wireless channel. The communications manager 820 may be configured as or otherwise support a means for modifying, associated with the target RTT, one or more transmit parameters of the wireless communication device. The communications manager 820 may be configured as or otherwise support a means for transmitting TCP data of the TCP flow over the wireless channel to the second wireless communication device according to the one or more modified transmit parameters.

In some implementations, the modifying the one or more transmit parameters may include reducing a TXOP duration of the wireless communication device. In some implementations, the modifying the one or more transmit parameters may include reducing a TX aggregation delay of the wireless communication device. In some implementations, the modifying the one or more transmit parameters may include modifying one or more EDCA parameters of the wireless communication device. In some implementations, the modifying the one or more EDCA parameters may include increasing a minimum contention window size. In some implementations, the modifying the one or more EDCA parameters may include increasing a maximum contention window size.

The communications manager 820 may be configured as or otherwise support a means for selecting the target RTT according to a bytes-in-flight of the TCP flow. The communications manager 820 may be configured as or otherwise support a means for selecting the target RTT according to the bytes-in-flight of the TCP flow and a physical layer communication rate of the second wireless communication device. The communications manager 820 may be configured as or otherwise support a means for obtaining an indication of the bytes-in-flight of the TCP flow from a device driver. The communications manager 820 may be configured as or otherwise support a means for, associated with the target RTT, selecting a TXOP duration for the wireless communication device. The communications manager 820 may be configured as or otherwise support a means for, subsequent to transmitting the TCP data of the TCP flow over the wireless link to the second wireless communication device according to the one or more modified transmit parameters, associated with an increase in a utilization level of the wireless channel, reverting at least one of the one or more modified transmit parameters to a previous value. In some implementations, the wireless communication device may be an AP of a WLAN, and the second wireless communication device may be a STA of the WLAN.

The communications manager 820 may be configured as or otherwise support a means for, associated with a utilization level of the wireless channel, checking an MSDU queue for a presence of MSDUs associated with TCP flows. The communications manager 820 may be configured as or otherwise support a means for, associated with a presence in the MSDU queue of MSDUs associated with the TCP flow, selecting the target RTT. The communications manager 820 may be configured as or otherwise support a means for, associated with a number of times per second that the MSDU queue becomes empty, checking the MSDU queue for bursty traffic. The communications manager 820 may be configured as or otherwise support a means for, associated with finding bursty traffic associated with a non-TCP flow in the MSDU queue, increasing an aggregation delay for MSDUs including data of the non-TCP flow.

In some implementations, the non-TCP flow can include a UDP flow. In some implementations, the non-TCP flow can include traffic associated with an EDCA VO access category. In some implementations, the non-TCP flow can include traffic associated with an EDCA VI access category.

In some implementations, the communications manager 820 may be configured to perform various operations (for example, receiving, monitoring, transmitting) using or otherwise in cooperation with the transceiver 815, the one or more antennas 825, or any combination thereof. Although the communications manager 820 is illustrated as a separate component, in some implementations, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of increasing TCP throughput by reducing TCP RTT in a wireless network as described herein, or the processor 840 and the memory 830 may be otherwise configured to perform or support such operations.

Implementation examples are described in the following numbered clauses:

Clause 1. A wireless communication device for wireless communication, including one or more interfaces operable to obtaining an indication of channel conditions of a wireless channel supporting a link between the wireless communication device and a second wireless communication device, where the link conveys a transfer control protocol (TCP) flow to the second wireless communication device, and a processing system operable to selecting a target round trip time (RTT) of the TCP flow in accordance with the channel conditions of the wireless channel, modifying, associated with the target RTT, one or more transmit parameters of the wireless communication device, and outputting TCP data of the TCP flow according to the one or more modified transmit parameters.

Clause 2. The wireless communication device of clause 1, where the modifying the one or more transmit parameters includes reducing a transmission opportunity (TXOP) duration of the wireless communication device.

Clause 3. The wireless communication device of any of clauses 1 to 2, where the modifying the one or more transmit parameters includes reducing a transmission (TX) aggregation delay of the wireless communication device.

Clause 4. The wireless communication device of any of clauses 1 to 3, where the modifying the one or more transmit parameters includes modifying one or more enhanced distributed channel access (EDCA) parameters of the wireless communication device.

Clause 5. The wireless communication device of clause 4, where the modifying one or more EDCA parameters of the wireless communication device includes increasing a minimum contention window size.

Clause 6. The wireless communication device of any of clauses 4 to 5, where the modifying one or more EDCA parameters of the wireless communication device includes increasing a maximum contention window size.

Clause 7. The wireless communication device of any of clauses 1 to 6, where the processing system is operable to selecting the target RTT according to a bytes-in-flight of the TCP flow.

Clause 8. The wireless communication device of clause 7, where the processing system is operable to selecting the target RTT according to the bytes-in-flight of the TCP flow and a physical layer communication rate of the second wireless communication device.

Clause 9. The wireless communication device of any of clauses 7 to 8, where the processing system is operable to obtaining an indication of the bytes-in-flight of the TCP flow from a device driver.

Clause 10. The wireless communication device of any of clauses 1 to 9, where the processing system is operable to, associated with the target RTT, selecting a transmission opportunity (TXOP) duration for the wireless communication device.

Clause 11. The wireless communication device of any of clauses 1 to 10, where the processing system is operable to, subsequent to transmitting the TCP data of the TCP flow over the wireless link to the second wireless communication device according to the one or more modified transmit parameters, associated with an increase in a utilization level of the wireless channel, reverting at least one of the one or more modified transmit parameters to a previous value.

Clause 12. The wireless communication device of any of clauses 1 to 11, where the wireless communication device is an access point (AP) of a wireless local area network (WLAN), and the second wireless communication device is a station (STA) of the WLAN.

Clause 13. The wireless communication device of any of clauses 1 to 12, where the processing system is operable to, associated with a utilization level of the wireless channel, checking a medium access control service data unit (MSDU) queue for a presence of MSDUs associated with TCP flows.

Clause 14. The wireless communication device of clause 13, where the processing system is operable to, associated with a presence in the MSDU queue of MSDUs associated with the TCP flow, selecting the target RTT.

Clause 15. The wireless communication device of any of clauses 13 to 14, where the processing system is operable to, associated with a number of times per second that the MSDU queue becomes empty, checking the MSDU queue for bursty traffic.

Clause 16. The wireless communication device of clause 15, where the processing system is operable to, associated with finding bursty traffic associated with a non-TCP flow in the MSDU queue, increasing an aggregation delay for MSDUs including data of the non-TCP flow.

Clause 17. The wireless communication device of clause 16, where the non-TCP flow includes a user datagram protocol (UDP) flow.

Clause 18. The wireless communication device of any of clauses 16 to 17, where the non-TCP flow includes traffic associated with an enhanced distributed channel access (EDCA) voice (VO) access category (AC).

Clause 19. The wireless communication device of any of clauses 16 to 18, where the non-TCP flow includes traffic associated with an enhanced distributed channel access (EDCA) video (VI) access category (AC).

Clause 20. A method for wireless communication by a wireless communication device, including obtaining an indication of channel conditions of a wireless channel supporting a link between the wireless communication device and a second wireless communication device, where the link conveys a transfer control protocol (TCP) flow to the second wireless communication device, selecting a target round trip time (RTT) of the TCP flow in accordance with the channel conditions of the wireless channel, modifying, associated with the target RTT, one or more transmit parameters of the wireless communication device, and transmitting TCP data of the TCP flow over the wireless channel to the second wireless communication device according to the one or more modified transmit parameters.

Clause 21. The method of clause 20, where the modifying the one or more transmit parameters includes reducing a transmission opportunity (TXOP) duration of the wireless communication device.

Clause 22. The method of any of clauses 20 to 21, where the modifying the one or more transmit parameters includes reducing a transmission (TX) aggregation delay of the wireless communication device.

Clause 23. The method of any of clauses 20 to 22, where the modifying the one or more transmit parameters includes modifying one or more enhanced distributed channel access (EDCA) parameters of the wireless communication device.

Clause 24. The method of clause 23, where the modifying one or more EDCA parameters of the wireless communication device includes increasing a minimum contention window size.

Clause 25. The method of any of clauses 23 to 24, where the modifying one or more EDCA parameters of the wireless communication device includes increasing a maximum contention window size.

Clause 26. The method of any of clauses 20 to 25, further including selecting the target RTT according to a bytes-in-flight of the TCP flow.

Clause 27. The method of clause 26, further including selecting the target RTT according to the bytes-in-flight of the TCP flow and a physical layer communication rate of the second wireless communication device.

Clause 28. The method of any of clauses 26 to 27, further including obtaining an indication of the bytes-in-flight of the TCP flow from a device driver.

Clause 29. The method of any of clauses 20 to 28, further including, associated with the target RTT, selecting a transmission opportunity (TXOP) duration for the wireless communication device.

Clause 30. The method of any of clauses 20 to 29, further including, subsequent to transmitting the TCP data of the TCP flow over the wireless link to the second wireless communication device according to the one or more modified transmit parameters, associated with an increase in a utilization level of the wireless channel, reverting at least one of the one or more modified transmit parameters to a previous value.

Clause 31. The method of any of clauses 20 to 30, where the wireless communication device is an access point (AP) of a wireless local area network (WLAN), and the second wireless communication device is a station (STA) of the WLAN.

Clause 32. The method of any of clauses 20 to 31, further including, associated with a utilization level of the wireless channel, checking a medium access control service data unit (MSDU) queue for a presence of MSDUs associated with TCP flows.

Clause 33. The method of clause 32, further including, associated with a presence in the MSDU queue of MSDUs associated with the TCP flow, selecting the target RTT.

Clause 34. The method of any of clauses 32 to 33, further including, associated with a number of times per second that the MSDU queue becomes empty, checking the MSDU queue for bursty traffic.

Clause 35. The method of clause 34, further including, associated with finding bursty traffic associated with a non-TCP flow in the MSDU queue, increasing an aggregation delay for MSDUs including data of the non-TCP flow.

Clause 36. The method of clause 35, where the non-TCP flow includes a user datagram protocol (UDP) flow.

Clause 37. The method of any of clauses 35 to 36, where the non-TCP flow includes traffic associated with an enhanced distributed channel access (EDCA) voice (VO) access category (AC).

Clause 38. The method of any of clauses 35 to 37, where the non-TCP flow includes traffic associated with an enhanced distributed channel access (EDCA) video (VI) access category (AC).

Clause 39. An apparatus for wireless communication by a wireless communication device, including means for obtaining an indication of channel conditions of a wireless channel supporting a link between the wireless communication device and a second wireless communication device, where the link conveys a transfer control protocol (TCP) flow to the second wireless communication device, means for selecting a target round trip time (RTT) of the TCP flow in accordance with the channel conditions of the wireless channel, means for modifying, associated with the target RTT, one or more transmit parameters of the wireless communication device, and means for transmitting TCP data of the TCP flow over the wireless channel to the second wireless communication device according to the one or more modified transmit parameters.

Clause 40. The apparatus of clause 39, where the modifying the one or more transmit parameters includes reducing a transmission opportunity (TXOP) duration of the wireless communication device.

Clause 41. The apparatus of any of clauses 39 to 40, where the modifying the one or more transmit parameters includes reducing a transmission (TX) aggregation delay of the wireless communication device.

Clause 42. The apparatus of any of clauses 39 to 41, where the modifying the one or more transmit parameters includes modifying one or more enhanced distributed channel access (EDCA) parameters of the wireless communication device.

Clause 43. The apparatus of clause 42, where the modifying one or more EDCA parameters of the wireless communication device includes increasing a minimum contention window size.

Clause 44. The apparatus of any of clauses 42 to 43, where the modifying one or more EDCA parameters of the wireless communication device includes increasing a maximum contention window size.

Clause 45. The apparatus of any of clauses 39 to 44, further including means for selecting the target RTT according to a bytes-in-flight of the TCP flow.

Clause 46. The apparatus of clause 45, further including means for selecting the target RTT according to the bytes-in-flight of the TCP flow and a physical layer communication rate of the second wireless communication device.

Clause 47. The apparatus of any of clauses 45 to 46, further including means for obtaining an indication of the bytes-in-flight of the TCP flow from a device driver.

Clause 48. The apparatus of any of clauses 39 to 47, further including means for, associated with the target RTT, selecting a transmission opportunity (TXOP) duration for the wireless communication device.

Clause 49. The apparatus of any of clauses 39 to 48, further including means for, subsequent to transmitting the TCP data of the TCP flow over the wireless link to the second wireless communication device according to the one or more modified transmit parameters, associated with an increase in a utilization level of the wireless channel, reverting at least one of the one or more modified transmit parameters to a previous value.

Clause 50. The apparatus of any of clauses 39 to 49, where the wireless communication device is an access point (AP) of a wireless local area network (WLAN), and the second wireless communication device is a station (STA) of the WLAN.

Clause 51. The apparatus of any of clauses 39 to 50, further including means for, associated with a utilization level of the wireless channel, checking a medium access control service data unit (MSDU) queue for a presence of MSDUs associated with TCP flows.

Clause 52. The apparatus of clause 51, further including means for, associated with a presence in the MSDU queue of MSDUs associated with the TCP flow, selecting the target RTT.

Clause 53. The apparatus of any of clauses 51 to 52, further including means for, associated with a number of times per second that the MSDU queue becomes empty, checking the MSDU queue for bursty traffic.

Clause 54. The apparatus of clause 53, further including means for, associated with finding bursty traffic associated with a non-TCP flow in the MSDU queue, increasing an aggregation delay for MSDUs including data of the non-TCP flow.

Clause 55. The apparatus of clause 54, where the non-TCP flow includes a user datagram protocol (UDP) flow.

Clause 56. The apparatus of any of clauses 54 to 55, where the non-TCP flow includes traffic associated with an enhanced distributed channel access (EDCA) voice (VO) access category (AC).

Clause 57. The apparatus of any of clauses 54 to 56, where the non-TCP flow includes traffic associated with an enhanced distributed channel access (EDCA) video (VI) access category (AC).

Clause 58. One or more non-transitory computer-readable media having instructions for wireless communication by a wireless communication device stored thereon which, when executed by a control system of the wireless communication device, cause the control system to obtain an indication of channel conditions of a wireless channel supporting a link between the wireless communication device and a second wireless communication device, where the link conveys a transfer control protocol (TCP) flow to the second wireless communication device, select a target round trip time (RTT) of the TCP flow in accordance with the channel conditions of the wireless channel, modify, associated with the target RTT, one or more transmit parameters of the wireless communication device, and transmit TCP data of the TCP flow over the wireless channel to the second wireless communication device according to the one or more modified transmit parameters.

Clause 59. The one or more non-transitory computer-readable media of clause 58, where the modifying the one or more transmit parameters includes reducing a transmission opportunity (TXOP) duration of the wireless communication device.

Clause 60. The one or more non-transitory computer-readable media of any of clauses 58 to 59, where the modifying the one or more transmit parameters includes reducing a transmission (TX) aggregation delay of the wireless communication device.

Clause 61. The one or more non-transitory computer-readable media of any of clauses 58 to 60, where the modifying the one or more transmit parameters includes modifying one or more enhanced distributed channel access (EDCA) parameters of the wireless communication device.

Clause 62. The one or more non-transitory computer-readable media of clause 61, where the modifying one or more EDCA parameters of the wireless communication device includes increasing a minimum contention window size.

Clause 63. The one or more non-transitory computer-readable media of any of clauses 61 to 62, where the modifying one or more EDCA parameters of the wireless communication device includes increasing a maximum contention window size.

Clause 64. The one or more non-transitory computer-readable media of any of clauses 58 to 63, having instructions stored thereon which, when executed by the control system of the wireless communication device, cause the control system to select the target RTT according to a bytes-in-flight of the TCP flow.

Clause 65. The one or more non-transitory computer-readable media of clause 64, having instructions stored thereon which, when executed by the control system of the wireless communication device, cause the control system to select the target RTT according to the bytes-in-flight of the TCP flow and a physical layer communication rate of the second wireless communication device.

Clause 66. The one or more non-transitory computer-readable media of any of clauses 64 to 65, having instructions stored thereon which, when executed by the control system of the wireless communication device, cause the control system to obtain an indication of the bytes-in-flight of the TCP flow from a device driver.

Clause 67. The one or more non-transitory computer-readable media of any of clauses 58 to 66, having instructions stored thereon which, when executed by the control system of the wireless communication device, cause the control system to, associated with the target RTT, select a transmission opportunity (TXOP) duration for the wireless communication device.

Clause 68. The one or more non-transitory computer-readable media of any of clauses 58 to 67, having instructions stored thereon which, when executed by the control system of the wireless communication device, cause the control system to, subsequent to transmitting the TCP data of the TCP flow over the wireless link to the second wireless communication device according to the one or more modified transmit parameters, associated with an increase in a utilization level of the wireless channel, revert at least one of the one or more modified transmit parameters to a previous value.

Clause 69. The one or more non-transitory computer-readable media of any of clauses 58 to 68, where the wireless communication device is an access point (AP) of a wireless local area network (WLAN), and the second wireless communication device is a station (STA) of the WLAN.

Clause 70. The one or more non-transitory computer-readable media of any of clauses 58 to 69, having instructions stored thereon which, when executed by the control system of the wireless communication device, cause the control system to, associated with a utilization level of the wireless channel, check a medium access control service data unit (MSDU) queue for a presence of MSDUs associated with TCP flows.

Clause 71. The one or more non-transitory computer-readable media of clause 70, having instructions stored thereon which, when executed by the control system of the wireless communication device, cause the control system to, associated with a presence in the MSDU queue of MSDUs associated with the TCP flow, select the target RTT.

Clause 72. The one or more non-transitory computer-readable media of any of clauses 70 to 71, having instructions stored thereon which, when executed by the control system of the wireless communication device, cause the control system to, associated with a number of times per second that the MSDU queue becomes empty, check the MSDU queue for bursty traffic.

Clause 73. The one or more non-transitory computer-readable media of clause 72, having instructions stored thereon which, when executed by the control system of the wireless communication device, cause the control system to, associated with finding bursty traffic associated with a non-TCP flow in the MSDU queue, increase an aggregation delay for MSDUs including data of the non-TCP flow.

Clause 74. The one or more non-transitory computer-readable media of clause 73, where the non-TCP flow includes a user datagram protocol (UDP) flow.

Clause 75. The one or more non-transitory computer-readable media of any of clauses 73 to 74, where the non-TCP flow includes traffic associated with an enhanced distributed channel access (EDCA) voice (VO) access category (AC).

Clause 76. The one or more non-transitory computer-readable media of any of clauses 73 to 75, where the non-TCP flow includes traffic associated with an enhanced distributed channel access (EDCA) video (VI) access category (AC).

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory), obtaining, and the like. Also, “determining” can include resolving, selecting, choosing, establishing, estimating, calculating, ascertaining and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described herein as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. A wireless communication device for wireless communication, comprising:
one or more interfaces capable of:
obtaining an indication of channel conditions of a wireless channel supporting a link between the wireless communication device and a second wireless communication device, wherein the link conveys a transfer control protocol (TCP) flow to the second wireless communication device; and
a processing system capable of:
selecting a target round trip time (RTT) of the TCP flow in accordance with the channel conditions of the wireless channel;
modifying, associated with the target RTT, one or more transmit parameters of the wireless communication device; and
outputting TCP data of the TCP flow according to the one or more modified transmit parameters.

2. The wireless communication device of claim 1, wherein the modifying the one or more transmit parameters includes reducing a transmission opportunity (TXOP) duration of the wireless communication device.

3. The wireless communication device of claim 1, wherein the modifying the one or more transmit parameters includes reducing a transmission (TX) aggregation delay of the wireless communication device.

4. The wireless communication device of claim 1, wherein the modifying the one or more transmit parameters includes modifying one or more enhanced distributed channel access (EDCA) parameters of the wireless communication device.

5. The wireless communication device of claim 4, wherein the modifying one or more EDCA parameters of the wireless communication device includes increasing a minimum contention window size.

6. The wireless communication device of claim 4, wherein the modifying one or more EDCA parameters of the wireless communication device includes increasing a maximum contention window size.

7. The wireless communication device of claim 1, wherein the processing system is capable of selecting the target RTT according to a bytes-in-flight of the TCP flow.

8. The wireless communication device of claim 7, wherein the processing system is capable of selecting the target RTT according to the bytes-in-flight of the TCP flow and a physical layer communication rate of the second wireless communication device.

9. The wireless communication device of claim 7, wherein the processing system is capable of obtaining an indication of the bytes-in-flight of the TCP flow from a device driver.

10. The wireless communication device of claim 1, wherein the processing system is capable of, associated with the target RTT, selecting a transmission opportunity (TXOP) duration for the wireless communication device.

11. The wireless communication device of claim 1, wherein the processing system is capable of, subsequent to transmitting the TCP data of the TCP flow over the wireless link to the second wireless communication device according to the one or more modified transmit parameters, associated with an increase in a utilization level of the wireless channel, reverting at least one of the one or more modified transmit parameters to a previous value.

12. The wireless communication device of claim 1, wherein the wireless communication device is an access point (AP) of a wireless local area network (WLAN), and the second wireless communication device is a station (STA) of the WLAN.

13. A method for wireless communication by a wireless communication device, comprising:
obtaining an indication of channel conditions of a wireless channel supporting a link between the wireless communication device and a second wireless communication device, wherein the link conveys a transfer control protocol (TCP) flow to the second wireless communication device;
selecting a target round trip time (RTT) of the TCP flow in accordance with the channel conditions of the wireless channel;
modifying, associated with the target RTT, one or more transmit parameters of the wireless communication device; and
transmitting TCP data of the TCP flow over the wireless channel to the second wireless communication device according to the one or more modified transmit parameters.

14. The method of claim 13, further comprising, associated with a utilization level of the wireless channel, checking a medium access control service data unit (MSDU) queue for a presence of MSDUs associated with TCP flows.

15. The method of claim 14, further comprising, associated with a presence in the MSDU queue of MSDUs associated with the TCP flow, selecting the target RTT.

16. The method of claim 14, further comprising, associated with a number of times per second that the MSDU queue becomes empty, checking the MSDU queue for bursty traffic.

17. The method of claim 16, further comprising, associated with finding bursty traffic associated with a non-TCP flow in the MSDU queue, increasing an aggregation delay for MSDUs comprising data of the non-TCP flow.

18. The method of claim 17, wherein the non-TCP flow comprises a user datagram protocol (UDP) flow.

19. The method of claim 17, wherein the non-TCP flow comprises traffic associated with an enhanced distributed channel access (EDCA) voice (VO) access category (AC).

20. The method of claim 17, wherein the non-TCP flow comprises traffic associated with an enhanced distributed channel access (EDCA) video (VI) access category (AC).
